(19) United States
(12) Patent Application Publication
(10) Pub. No.: US 2024/0108553 A1
(43) Pub. Date: Apr. 4, 2024

(54) DEVICE FOR FEEDING A PREMATURE INFANT

(71) Applicant: Preemie-Pacer, LLC, O'Fallon, MO (US)

(72) Inventors: Roberta Pineda, Altadena, CA (US); Jeffrey Macler, Tecumseh, MO (US)

(21) Appl. No.: 17/956,199

(22) Filed: Sep. 29, 2022

(51) Int. Cl. A61J 9/00

(52) U.S. Cl. CPC A61J 9/006; A61J 2200/76

(57) ABSTRACT

An infant feeding device intended for oral feeding of premature infants. The device is adapted to regulate the flow of fluid fed to the infant. The device may also be adapted to receive and record data relevant to each feeding session. The device further includes disposable components that are appropriate for contact with human milk and formula.

### STATEMENT REGARDING FEDERALLY SPONSORED RESEARCH OR DEVELOPMENT

This invention was made with government support under the SBIR NIH Grant 13083451 awarded by the National Institutes of Health. The government has certain rights to the invention.

### RELATED PATENT APPLICATIONS AND INCORPORATION BY REFERENCE

Not applicable.

### FIELD OF THE INVENTION

The present invention relates to the field of devices for oral feeding of premature infants.

### BACKGROUND OF THE INVENTION

The average gestation period of a human being is generally considered to be 280 days, or around 40 weeks. Recent science has indicated that birth, without any medical intervention or complications of preterm birth, will on average occur a little over 38 weeks after fertilization. Generally, an infant born from 37-42 weeks after conception is considered to be “full term.” A large number of babies, however, are born prior to this period. In the United States, around 10% of babies born each year are considered to be “preterm,” that is, before the 37^{th} week. Some of these births occur spontaneously occur due to complications in pregnancy. Others are scheduled early due to the need for planned Cesarean section births, some are due to induced labor following abnormal lab results, and others from concern that an infant is getting too large to be easily delivered.

Regardless of the reason that an infant is born preterm, preterm infants (and even those born in the 38^{th} and 39^{th} week compared to those born later) generally have more medical issues at birth than full-term infants. For example, infant mortality rates for preterm infants are generally double those of full-term infants. Another problem associated with preterm babies is that they have trouble eating and learning how to eat. The act of nursing (or alternatively eating from a bottle) generally requires an infant to follow a pattern usually referred to as “suck-swallow-breathe.” In this pattern, an infant sucks once, swallows once, breathes once, and then repeats. Preterm infants, however, may feed with repetitions of 3 or 4 (or more) sucks and swallows and 1 breathing break. Moreover, many preterm infants have trouble maintaining pattern, and an inability to feed can lead to further complications with the infant. For example, this can result in increased medical expense due to the need to keep the infant at a hospital.

Because many preterm infants (and particularly very early preterm infants) are maintained in a Neonatal Intensive Care Unit (NICU), they are often bottle fed (breastfeeding is a challenge) and effective feeding patterns must be imposed until the infant's central nervous system matures to enable coordination of the suck-swallow-breathe pattern. While preterm infants often demonstrate adequate suction and compression on the bottle to express milk very early in gestation, the infant's immature central nervous system does not signal the infant to pause for respiration, which results in inadequate oxygen in the blood and dangerous drops in heart rate.

In the months prior to term equivalent age, cautious caregivers can promote an imposed breathing break by allowing the infant to take a few sucks from the bottle followed by pulling the bottle out of the infant's mouth. This procedure requires special expertise and considerable time; causes the infant significant energy expenditure and physiological stress; and disrupts the feeding process. The complexities of feeding infants delay discharge and increase hospital costs. NICU nurses and therapists currently manually pace preterm infants during bottle feeding, and parents are often taught how to pace preterm infants during oral feeds. It has been found that many preterm infants will continue sucking until prompted to swallow and breathe by the feeder.

During feeding, monitors attached to the infants in the NICU collect data regarding respiration, heart rate, and other vital signs to assist the nurse in knowing when to prompt the infant to swallow and breathe. However, these monitors often take longer to alert a nurse than desired. Thus, feeding of infants that lack successful suck-swallow-breathe coordination typically requires the nurse to analyze the infant's facial features for signs of stress, such as raised eyebrows, breathing difficulty, or blue discoloration. In effect, the need to pause feeding is mostly dependent on the feeder's skill and experience in feeding such infants. This can make it exceedingly problematic for feeding to be carried out by parents, or other non-specialized personnel, as they simply lack the experience of feeding to know how to correctly recognize signs of stress quickly.

When the NICU nurse detects that the infant needs to breathe, the nurse typically tilts or, if necessary, completely removes the bottle to stop the flow of liquid from the bottle. There are a number of different processes, but each effectively recognized that the need to halt the flow of fluid needs be paired with a need to not overly disrupt the act of feeding and, particularly, being correctly latched to the bottle. The lack of milk typically cues the infant to swallow and begin breathing again. If done correctly, once a breath is taken, the bottle can be returned to the normal feeding position and the infant will commence sucking again. This system is highly subjective to human intervention, however, and requires constant attention during feeding to minimize the possibility of risks such as choking or aspiration. Further, it requires a considerable amount of skill to halt fluid flow from the bottle while not overly interrupting the feeding cycle to the point where it may be difficult to get the infant to resume. This is also all balanced within time constraints for the amount of time the feeding may take to allow nurses and other skilled staff to meet the needs of all the patients in a NICU.

Many infants will also eventually pick up the rhythm of suck-swallow-breathe after only a few repetitions of a forced-pace system, and it is desirable for infants that quickly pick up the pattern to begin pacing naturally without a forced-pace being imposed. This allows them to maintain their own pattern and maintain their own pace while both maximizing the amount of intake and allowing necessary connections in how to feed to be made. Removing or even maneuvering the bottle to cease fluid flow is necessarily disruptive to feeding behavior and can cause problems with the infant establishing a pattern, gaining an adequate swallow on fluid that has been expressed, and/or re-establishing the feeding response.

### SUMMARY OF THE INVENTION

The following is a summary of the invention that should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, it is desirable to provide a feeding device that eliminates the need to constantly monitor a feeding in a preterm infant and manually alter the flow of liquid in a bottle.

There is described herein, among other things, an embodiment of an infant feeding device for controlling the flow of a feeding fluid, the device comprising: a bottle; a tube in fluid communication with the bottle and having a hollow volume and two opposing ends; a nipple in fluid communication with the tube; and a control device for obstructing flow of fluid through the tube; wherein the control device is configured to regulate the obstruction of the flow of fluid through the tube in a closed state; and wherein the control device is configured to not obstruct flow of fluid through the tube in an open state. The embodiment further allows for data capture regarding each infant feeding session.

In an embodiment of the feeding device, the tube extends from the tip of the nipple to the main body 4.

In an embodiment of the feeding device, the bottle is a rigid bottle.

In an embodiment of the feeding device, the infant is a preterm infant.

In an embodiment of the feeding device, the bottle further comprises a feeding reservoir formed in the nipple, and wherein the tube extends from the feeding reservoir formed in the nipple, and wherein the tube extends from the feeding reservoir to the bottle.

In an embodiment, the feeding device further comprises a control system for activating a solenoid switch to either pinch or relieve pressure on the tubing which connects the bottle to the nipple, thereby acting as a pinching mechanism for either stopping or starting the fluid flow.

There is also described herein, in an embodiment, a feeding device for controlling the flow of a feeding fluid, the device comprising: a bottle; a tube in fluid communication with the bottle and having a hollow volume and two opposing ends; a nipple in fluid communication with the tube; and a pinching mechanism positioned proximate to the tube; wherein the pinching mechanism is configured to obstruct flow of fluid through the tube in a closed state; wherein the pinching mechanism is configured to not obstruct flow of fluid through the tube in an open state; and wherein the pinching mechanism is biased toward the open state and will move to the closed state only upon action of a user of the baby bottle.

In an embodiment, the feeding device further comprises a feeding reservoir formed in the nipple, and wherein the tube extends from the feeding reservoir to the bottle.

There is also described herein, in an embodiment, a feeding device for controlling the flow of a feeding fluid, the feeding device comprising: a bottle; a tube in fluid communication with the bottle and having a hollow volume and two opposing ends; a nipple in fluid communication with the tube; and a pinching mechanism positioned proximate to the tube, wherein the pinching mechanism is configured to obstruct flow of fluid through the tube in a closed state; wherein the pinching mechanism is configured to not obstruct flow of fluid through the tube in an open state; and wherein the pinching mechanism is biased toward the closed state and will move to the open state only upon action of a user of the baby bottle.

### BRIEF DESCRIPTION OF THE DRAWINGS

FIG. 1 is a perspective view of an embodiment of a feeding device according to the present invention.

FIG. 2 is an exploded view of an embodiment of a feeding device according to the present invention.

FIGS. 3A and 3B provide, respectively, a side view and top view of an embodiment of a feeding device according to the present invention.

FIG. 4 is an exploded view of a cartridge of an embodiment of a feeding device according to the present invention.

FIG. 5 is a perspective view of an unassembled cartridge of an embodiment of a feeding device according to the present invention.

FIG. 6 is a perspective view of a control device and cartridge of an embodiment of a feeding device according to the present invention

FIG. 7 is a top view of a control device and cartridge assembly being directed towards engagement with a bottle

FIG. 8 is a perspective view of a control device and a cartridge attached to a bottle of an embodiment of a feeding device according to the present invention.

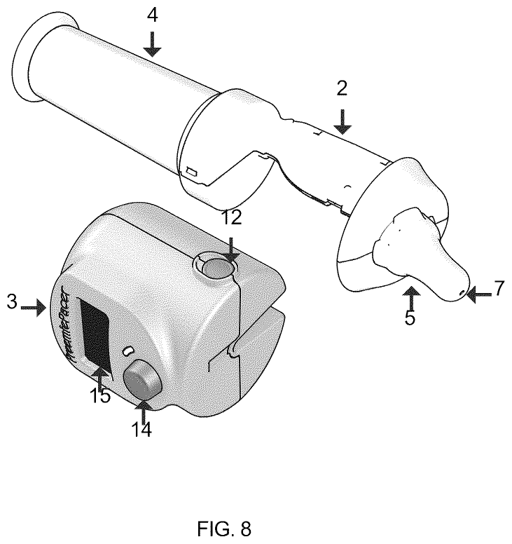

FIG. 9 is a top view of a cartridge being directed towards engagement with a bottle.

FIG. 10 is a perspective view of a user's hand holding an embodiment of a feeding device according to the present invention being used to feed an infant.

FIG. 11 is a perspective view of a user's hand holding an embodiment of a feeding device according to the present invention, with the flow button released.

FIG. 12 is a top view of a preferred embodiment of a feeding device according to the present invention.

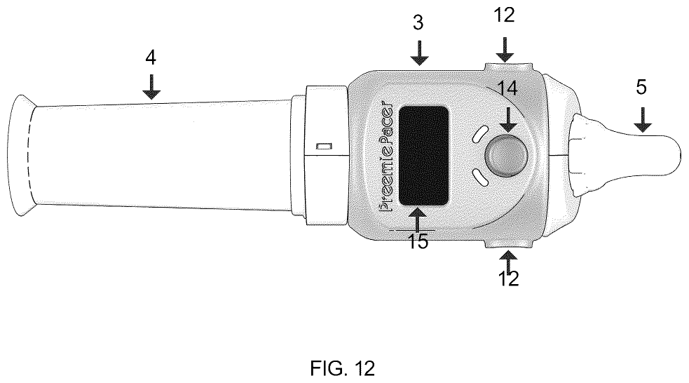

FIG. 13 is a side view of a preferred embodiment of a feeding device according to the present invention.

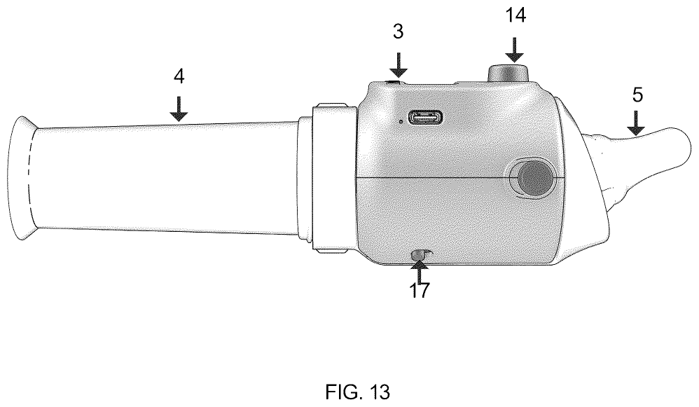

FIG. 14 is a bottom view of a preferred embodiment of a feeding device according to the present invention.

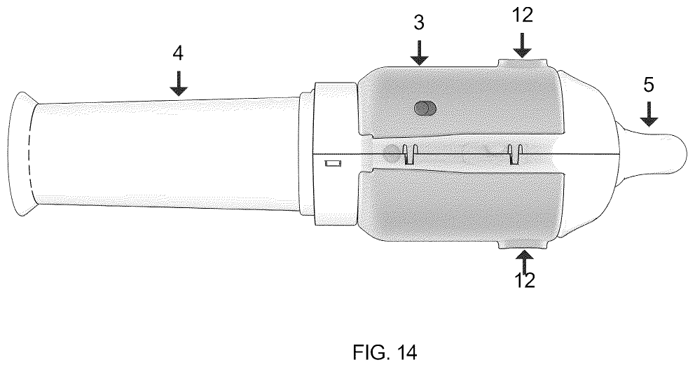

### DETAILED DESCRIPTION

The following detailed description is merely exemplary in nature and is not intended to and should not be interpreted to limit the embodiments described herein. Although particular embodiments are described, those embodiments are merely exemplary implementations of the present invention. The following descriptions herein should be considered illustrative in nature, and thus, not in any way limiting the scope of the present invention. One skilled in the art will recognize other embodiments are possible and all such embodiments are intended to fall within the scope of the present disclosure. It is the intent is to include all alternatives, modifications and equivalents that embody the spirit and scope of the disclosure.

It is also to be understood that the disclosure uses terminology for the purpose of describing particular embodiments and such terminology is not intended to be limiting.

Unless defined otherwise, all technical and scientific terms used in this disclosure have the same meaning as commonly understood by one of ordinary skill in the art to which is applicable to this disclosure.

As will be apparent to those of skill in the art upon reading this disclosure, each of the embodiments described herein has discrete components and features which may be readily separated or combined with features of any of the other possible embodiments without departing from the spirit and scope of the present disclosure.

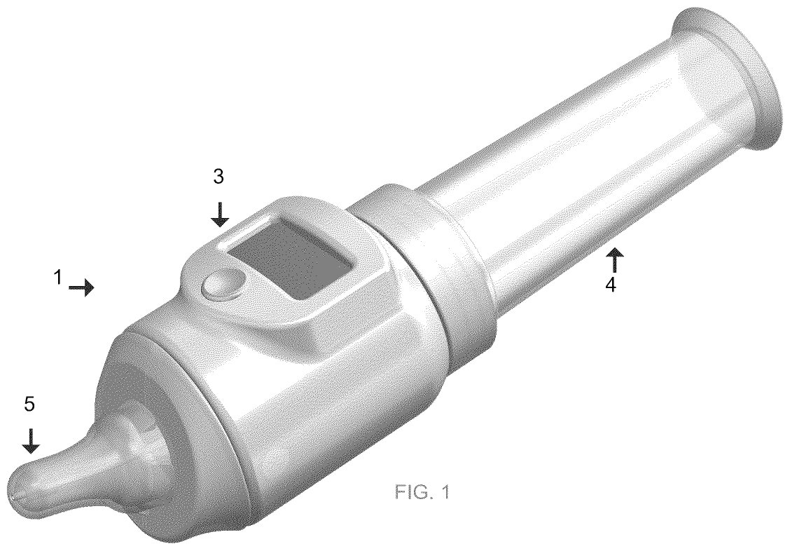

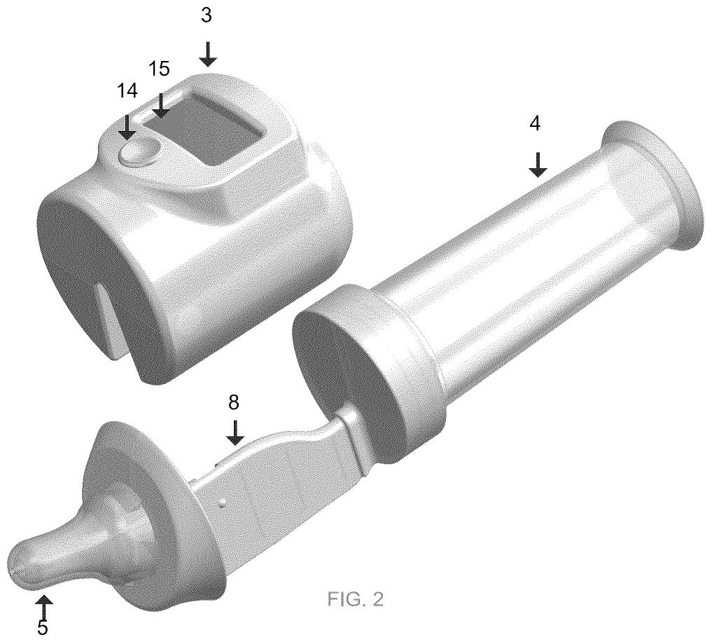

A preferred embodiment of the present invention is shown in FIGS. 1 and 2 is comprised of a bottle 1, a cartridge 2, and a control device 3. The bottle 1 is of standard design, preferably a standard Grad-U-Feeder for example, and comprises a main body 4, which is used to house milk, formula, or another liquid product for feeding an infant. The cartridge 2 contains a nipple 5, medical grade tubing 6, and accepts a standard 40 mm neck bottle for milk or formula. The cartridge 2 may be sized in any manner to accept various other neck bottle sizes as well. The nipple 5 allows for an infant to suck upon it in order to draw fluid from the bottle 1. In a traditional operation, the bottle is filled with fluid and the cartridge is screwed onto a mating screw ring on the bottle. The bottle 1 may then be inverted, placing the nipple 5 below the main body 4 of the bottle 1. Fluid flows from the bottle 1 into the nipple 5 and may be held in place inside the nipple 5 or may begin to flow depending on the construction of the bottle 1.

The nipple 5 will generally include at least one hole 7 at its distal end through which fluid can pass. For very young infants, the hole 7 is usually sufficiently small that the surface tension of the fluid will not allow it to pass through without pressure being applied. An infant is fed by placing the nipple 5 in their mouth. They will generally instinctually suck on the nipple 5 pulling the fluid through the hole 7 and into their mouth. For an infant that has suck-swallow-breathe activity, once the infant has sufficient fluid in their mouth, they will cease sucking on the nipple 5 and swallow. They will then breathe, which may relax the pressure generated in the nipple 5.

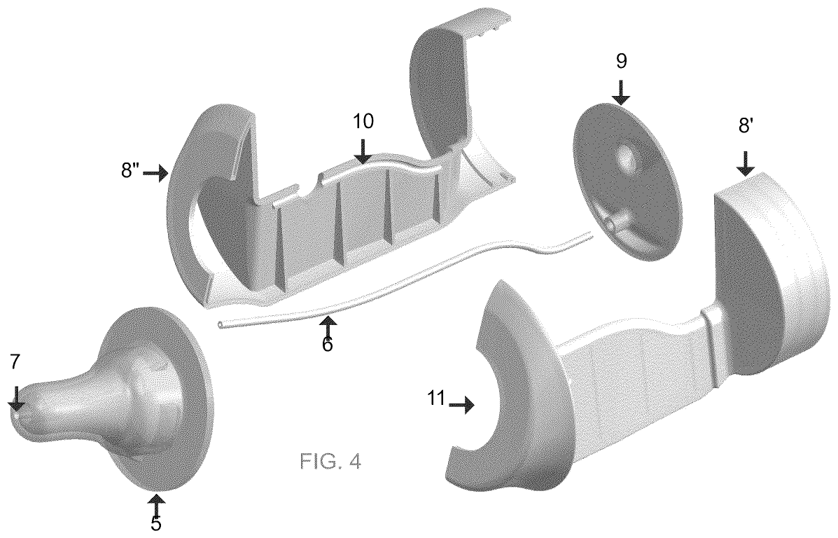

FIG. 4 shows a cartridge 2 of an embodiment of the present invention comprising four major components: a plastic shell 8; a nipple 5; silicone tubing 6; and a silicone bottle cap 9. The cartridge 2 serves as the main structure and base of the feeding device of the present invention and its component parts. As shown in FIG. 4, the nipple 5, tubing 6 and bottle cap 9 are housed within the cartridge shell 8. The cartridge shell 8 may be molded separately as corresponding left and right parts 8′, 8″, which can be glued, snapped or welded together to form the single, unitary shell that houses the nipple 5, tubing 6 and bottle cap 9. At the interior of its base, the cartridge 2 is threaded in order to allow for the bottle 1 to be securely screwed onto the cartridge 2, without the need for an attachment device, such as a collar, to secure the bottle 1 to the cartridge 2. Typically, the center section of the cartridge 2 will be made from a material that provides sufficient rigidity to keep the bottle 1 and nipple 5 in proper alignment. Further, as can also be seen in FIG. 4, the cartridge 2 may be designed to include a channel 10 which holds in place and guides the tubing 6 in its preferred orientation. As also shown in FIG. 4, the cartridge 2 of the preferred embodiment shown has a tubing pinch area 11, which is comprised of an opening in the cartridge shell 8 which allows a pinching mechanism (not shown) to pinch the tubing 6, thereby interrupting the flow of fluid through the tubing 6 and the nipple 5. A suitable pinching mechanism is preferably employed so that the flow of fluid through the nipple 5 may be regulated in an advantageous manner.

The pinching mechanism (not shown) is preferably activated by a flow button 12 which activates a solenoid switch to either pinch or relieve pressure on the tubing 6 that connects the bottle 1 to the nipple 5. Pressing the flow button 12 activates the pinching mechanism to release from the tubing 6, thereby permitting the flow of fluid, allowing the infant to drink freely. Releasing the flow button 12, conversely, interrupts the flow of fluid.

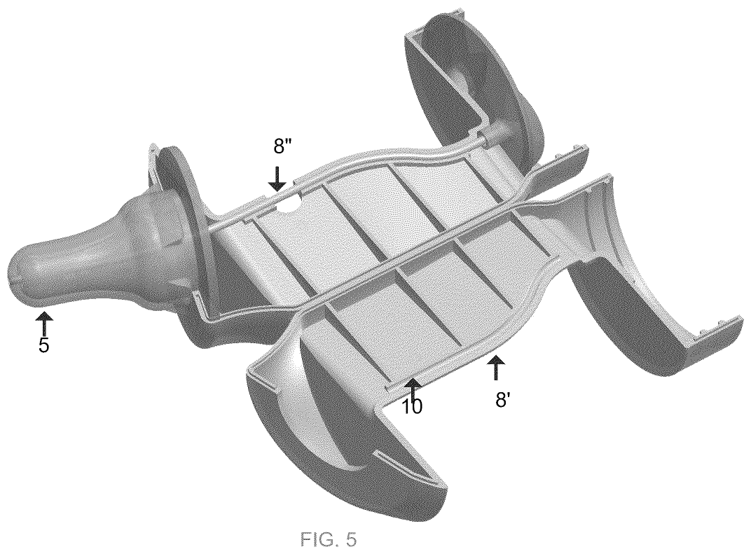

The tube typically extends through the nipple 5 from within the cartridge 2 and may extend into the main body 4. In the embodiment shown in FIG. 5, the tubing 6 is positioned so as to be in contact with the end of the nipple 5 and will be generally positioned so as to place its hollow internal volume in contact with a hole 7 located at the end of the nipple 5, which is a common arrangement in conventional bottle nipples. This configuration insulates the hollow internal volume of the tube 9 from the environment around the bottle 1.

The tubing 6 may be co-formed with the nipple 5 so as to provide for the positioning discussed above, or alternatively it may be manufactured separately. Further, the nipple 5 may include a positioning guide or a mount that allows for the tubing 6 to be reliably positioned. For example, the forward end of the tubing 6 may act as a male connector with a molded mating female connector being positioned in the inside of the tip of the nipple 5. Alternatively, the tubing 6 may simply be positioned in a manner that is not directly adjacent to the nipple hole 7, but positioned within a void inside the nipple 5 that is formed by a barrier (not shown in the FIGS), which void may comprise the entire internal volume of the nipple 5 and which may be in contact with the nipple hole 7 and the tubing 6.

Regardless of how the tubing 6 is connected to the nipple hole 7, the arrangement of the tubing 6 and nipple 5 will create a fluid reservoir. More specifically, the reservoir is the fluid that is within the portion of the internal volume of the tubing 6 forward of the area where the tubing 6 may be pinched, along with any void located prior to the nipple hole 7. For ease of reference, and regardless of embodiment or volume, this volume of fluid is referred to herein as the “feeding reservoir.” However, if a barrier was present and the tubing 6 was retracted slightly so as to create a gap between the end of the tubing 6 and the end of the nipple 5, allowing fluid flow between them, the feeding reservoir would comprise the combined volume of the portion of the internal volume of the tubing 6 forward of the pinch in the tubing 6 and the void within the nipple 5.

The tubing 6 will generally extend from the bottle 1 through the cartridge 2 and into the nipple. The tubing is preferably constructed of medical silicone or similar material, but could also be constructed of material similar to that which forms the nipple 5. In order to position the tubing, the tubing will generally be placed first inside the nipple 5 through its open back end and then simply pushed up into contact with the tip of the nipple 5. Alternatively, the tubing may be threaded through the tip of the nipple 5, wherein the hole will generally be the end of the hollow interior of the tubing as opposed to there being a separate hole formed by the nipple 5. The tubing may be considered to be “thick walled” and could have a wall thickness greater than or equal to the diameter of the internal volume of the tube.

The control device 3 of a preferred embodiment is provided for controlling the stopping and resuming of fluid at intervals dictated by the user. The control device 3 comprises an electrical power source, a control panel, and a pinching mechanism designed to modulate the flow of fluid from the nipple 5, all of which are encased within the control device housing 13. The electric power source may be batteries or any other suitable power source known in the art. In one embodiment, the power source is a Lithium ion battery that is rechargeable via a USB-C cable using a PC USB port or standard wall charger.

The control device housing 13 can be made of plastic or any other suitable material. The control device housing 13 is configured such that it can be releasably secured to the cartridge 2, for example by way of any conventional snap fit configuration known in the art.

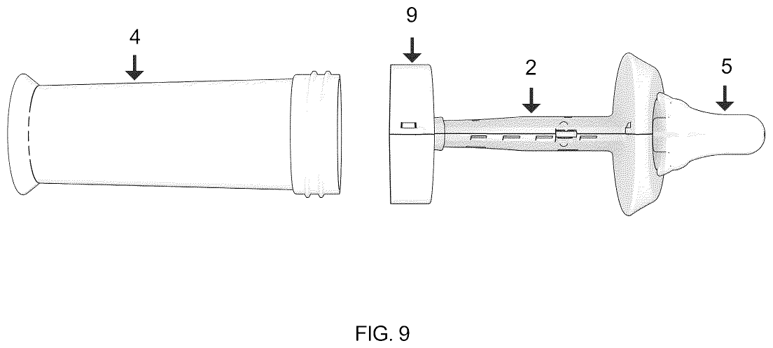

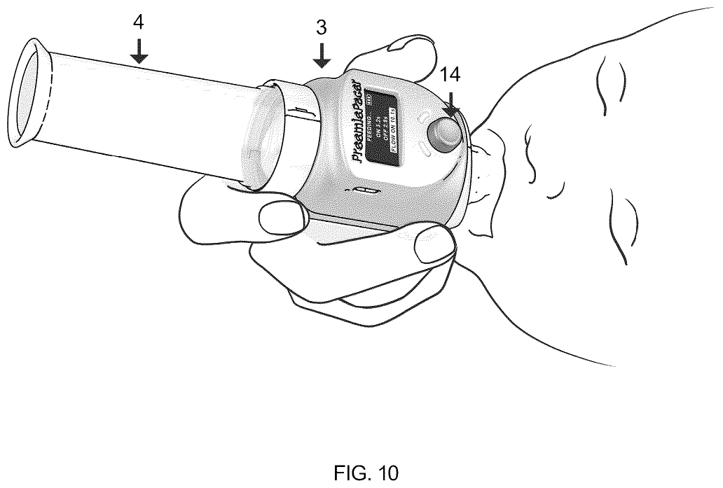

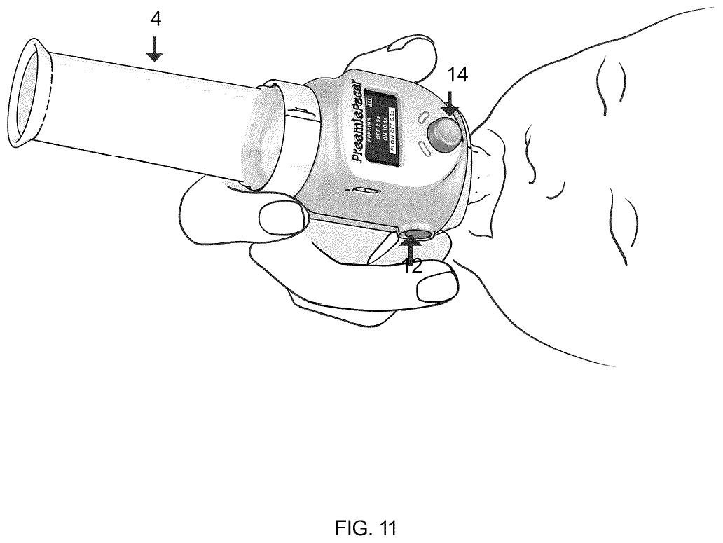

The preferred embodiment flow of FIG. 9 shows the front face of the control device 3, comprising an input knob 14, an LED screen 15, and flow indicator lights 16. As can be seen in FIG. 10, the control device 3 further comprises on its side, a first flow button 12, a USB-C port, a charge indicator light, and a power switch. A second flow button (not shown) may be positioned on the opposite side of the control device 3. FIG. 11 shows a power switch 17 positioned on the back side of the control device 3.

The input knob 14 is provided to highlight and select menu items indicated on a screen provided on the control panel, through which the LEDs may be viewed for indicating various settings and the mode in which the feeding device has been placed. The input knob 14 is designed to turn, allowing the user to select menu items or change values on the LED screen 15. One or more LEDs may be connected to the device's power source (i.e., battery) through a circuit board. The LEDs are managed by electrical signals elicited by activation of the input knob 14. Menu items may be pre-selected and highlighted by turning the input knob 14, wherein turning the input knob 14 clockwise moves the selection down and, conversely, turning the input knob 14 counterclockwise moves the selection up. One detent on the input knob 14 corresponds to moving one selection up or down. An input selection displayed on the LED screen 15 may be made by pressing the input knob 14 to select the highlighted desired input. Preselection highlighting may be indicated in a number of ways, including by flashing the highlighted text or by inverting the color of the text.

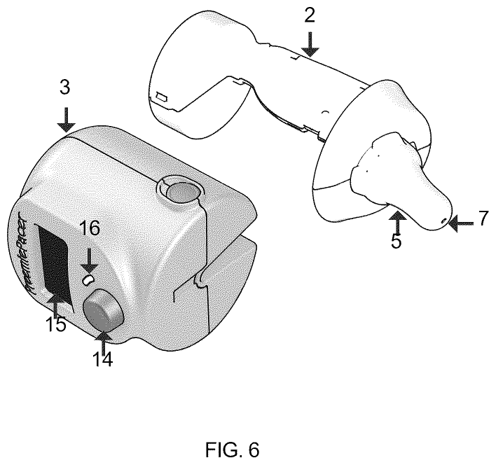

The feeding device may be assembled for use in a number of ways. Regardless of the manner of assembly, the assembly should begin with the power switch in the “OFF” position. The user (the person who will use the feeding device to administer fluid to an infant) may align the cartridge 2 and control device 3, in the manner shown in FIG. 6A, and push the cartridge 2 into the control device 3 until it snaps in place. The user may then fill the bottle 1 with the desired amount of fluid and, while holding the bottle 1 vertically, screw the bottle 1 onto the corresponding threaded opening of the cartridge 2 (see FIG. 6B).

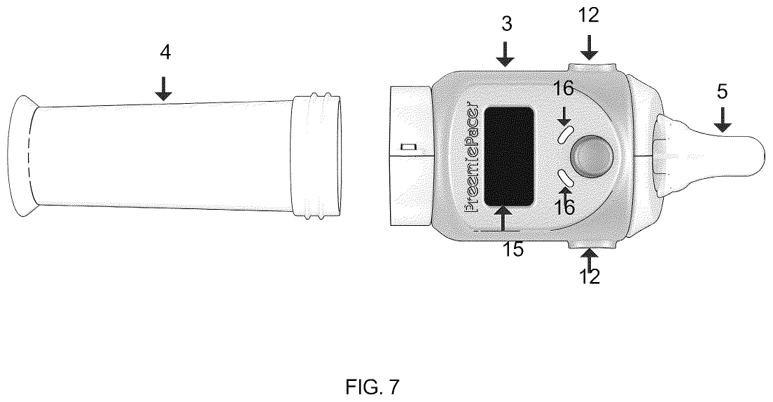

Alternatively, the user may first fill the bottle 1 with the desired amount of fluid. While holding the bottle 1 upright and vertical, the user may then screw the bottle 1 onto the corresponding threaded opening of the cartridge 2 (see FIG. 7A). Finally, the user may align the cartridge 2 and control device 3, in the manner shown in FIG. 7B, and push the cartridge 2 into the control device 3 until it snaps in place.

In use, a user may slide the power switch to the “ON” position. The user may then turn the input knob 14 to select the “Manual Feeding” mode, which then is followed by the LED screen 15 displaying prompts to enter various types of input data, such as “Baby ID,” “Baby PMA,” and “Starting Volume.” In a preferred embodiment, “Baby ID” represents a number assigned to each infant involved in an infant feeding study; “Baby PMA” represents the postmenstrual age in weeks equal to the infant's gestational age+birth age measured in weeks; and “Starting Volume” represents the volume of fluid in the bottle 1 at the start of a feeding session. The feeding device also may provide menu options on the LED screen 15, which may be selected using the input knob 14, to set the time and date so that feeding data can be recorded and assigned the applicable date and time. The preferred embodiment further includes an internal microprocessor for recording and downloading all feeding cycles and patterns, volumes of fluid consumed during each feeding, infant and user identification codes, infant postmenstrual age, and dates and times of feeding. Following the input of the prompted data, the user may then press the input knob 14 to begin a feeding session.

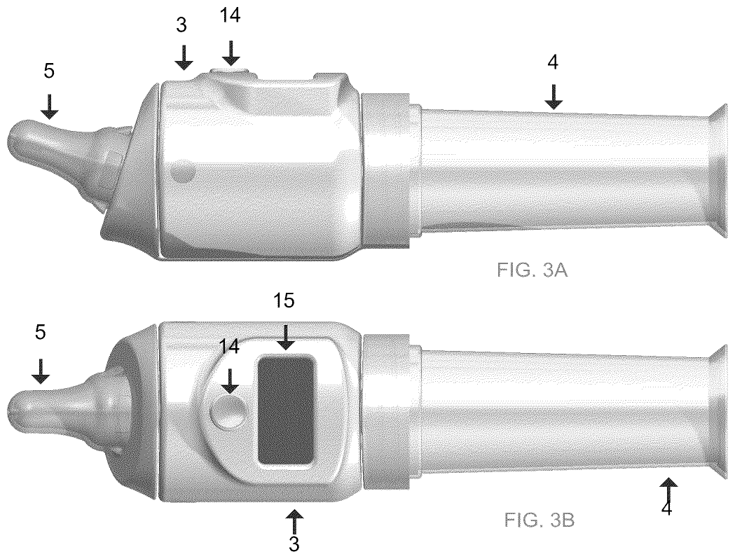

When the user is ready to begin a feeding session, the user holds the feeding device with the LED screen 15 facing in an upward direction. The user will then place their middle or index finger on one of the first or second flow buttons 12, depending upon which hand the user employs and which flow button 12 is within reach of the user's middle or index finger. The choice of two separate flow buttons 12 positioned on opposite sides of the control device 3 allows for the use of the feeding device with either the user's right or left hand. The preferred embodiment shown in FIGS. 3A and 3B, includes a first flow button 12 and a second flow button (not shown), however it is possible to have an embodiment with only one flow button 12 positioned on either side of the control device 3.

The user next places the nipple 5 in the infant's mouth and when the user's finger touches the flow button 12, fluid from the bottle 1 will be available to the infant upon the infant sucking the nipple 5 and the flow indicator light 16 will signal that fluid is available by lighting up in a particular color, such as green. The LED screen 15 may also display text that indicates fluid is available as well. As long as the user keeps their finger in contact with the flow button 12, fluid will be available to the infant. Flow will be stopped by an internal valve when the user removes their finger from the flow button 12. The interruption of fluid flow may be indicated by the flow indicator light 16 signaling the stoppage of flow by lighting up in a particular color, such as red. The text displayed in the LED screen 15 may also indicate when fluid flow is stopped. A feeding session may also be paused by the user pressing the input knob 14, which elicits a pause screen on the LED screen 15 where the user may use the input knob 14 to select the prompt to resume the feeding session or to end the feeding session. Upon ending a feeding session, the user may use the input knob 14 to follow the prompts on the LED screen 15 to record the remaining fluid volume in the bottle 1.

Upon completion of a feeding session, the user may connect the feeding device to a personal computer using a standard USB-C cable. Once the feeding device is connected to the personal computer, the user may then download the feeding data files to the personal computer.

In yet another embodiment of the present invention, the feeding device's internal microprocessor is programmed to include an assessment mode, wherein the feeding device will not only capture the timing and sequence of starts and stops in feeding, but will also allow data capture for each feeding session for a variety of measures, such as total volume of fluid consumed and total time spent feeding, which can be downloaded to a personal computer in the manner described above in order to monitor infant feeding trends and performance. A memory chip may be provided on the printed circuit board to store information from runs and stops triggered by the user's activation of the flow button 12 and also to store advanced programming developed the data for replay of specific sequences of stops and runs of fluid. This data collection capability will pull information based on the number of cycles of the feeding device in relation to the setting, which will be visible on the display screen.

It should be understood and recognized that the embodiments described herein and illustrated in the FIGS are merely exemplary and various other arrangements and assemblies of the present invention's components are possible. Moreover, the various parts and components described above may be made from any suitable material and constructed in a variety of different ways. For example, in some embodiments, the device components, such as the cartridge 2 and the bottle 1, may be designed to be disposable after a single use. In some embodiments, any one of the components may be reusable, potentially with minimal cleaning and/or sterilization.

After a feeding session is completed, the user may disassemble the bottle 1, cartridge 2 and control device 3, dispose of the single-use components (i.e., the cartridge 2 and bottle 1), and sterilize the control device 3 with a suitable disinfectant. The user may also recharge the battery by switching the power switch to the “ON” position and plugging a USB-C cable into the control device USB-C port, with the other end of the cable plugged into a suitable AC/DC adapter (i.e., phone charger) or personal computer USB port. When the battery is charging, the Charge Indicator Light of the control device may indicate charging status by illuminating a particular color, such as blue. When the battery has been sufficiently charged, the user may switch the power switch to the “OFF” position and store the feeding device for later use.

Having described the preferred embodiment of the present invention, any number of changes, variations and improvements which may be apparent to those skilled in the art are within the scope of the invention claimed and described herein.

What is claimed is:

1. A feeding device for oral feeding of an infant, comprising:
a bottle;
a cartridge comprising
tubing that has a hollow volume and two opposing ends and is in fluid communication with the bottle and
a nipple in fluid communication with the tubing; and
a control device connected to a source of electric power and programmed to activate a pinching mechanism to either pinch or relieve pressure on the tubing, thereby either stopping or starting fluid flow through the tubing and nipple.

2. A feeding device according to claim 1, wherein the control device activates the pinching mechanism under the control of a solenoid switch to either pinch or relieve pressure on the tubing.

3. A feeding device according to claim 1, wherein the tubing extends from the tip of the nipple to the bottle.

4. A feeding device according to claim 1, wherein the tubing extends from the tip of the nipple to a bottle interface.

5. A feeding device according to claim 1, wherein the control device is programmed to record stops and runs of fluid flow performed by the feeding device.

6. A feeding device according to claim 1, wherein the control device includes a flow button that is configured to initiate a signal to the pinching mechanism for controlling fluid flow through the tubing and nipple.

7. A feeding device according to claim 6, wherein the control device permits fluid flow through the nipple upon a user pressing the flow button.

8. A feeding device according to claim 6, wherein the control device completely stops fluid flow through the nipple when the flow button is released.

9. A feeding device according to claim 1, wherein the control device comprises at least two flow buttons, each configured to initiate a signal to the pinching mechanism for controlling fluid flow through the tubing and nipple.

10. A feeding device according to claim 9, wherein a first flow button is located on one side of the control device for right-handed use of the feeding device and a second flow button is located on an opposite side of the control device for left-handed use of the feeding device.

11. A feeding device according to claim 1, wherein the control device is secured to the cartridge by one of a snap-fit, press fit, latched or locked configuration.

12. A feeding device according to claim 1, wherein the bottle and cartridge are single-use and disposable.

13. A feeding device according to claim 1, wherein the source of electric power is a rechargeable battery.

14. A feeding device according to claim 1, wherein the bottle is a standard Grad-U-Feeder.

15. A feeding device for oral feeding of an infant, comprising:
a bottle;
a cartridge comprising tubing that is in fluid communication with the bottle and a nipple in fluid communication with the tubing; and
a control device comprising an input knob and a display screen, wherein the control device is programmed to receive and store input data.

16. A feeding device according to claim 15, wherein the input knob is configured to be deployed by a user to select menu items or change values displayed on the display screen.

17. A feeding device according to claim 16, wherein the input knob is configured to be deployed by turning in either a clockwise or counterclockwise direction.

18. A feeding device according to claim 15, wherein the display screen is an LED display screen.

19. A feeding device according to claim 15, wherein the control device further comprises an internal microprocessor for recording data.

20. A feeding device according to claim 19, wherein the internal microprocessor is programmed to record any one or more types of data selected from the group consisting of: a volume of fluid consumed; an infant identification code; a user identification code; infant postmenstrual age; total feeding time; and date and time of feeding.

21. A feeding device according to claim 19, wherein the internal microprocessor is adapted to record the stops and runs of fluid flow performed by the feeding device.

22. A feeding device according to claim 15, wherein the control device is adapted to be connected to a personal computer for downloading the stored input data.
